(19) United States
(12) Patent Application Publication
(10) Pub. No.: US 2024/0220596 A1
(43) Pub. Date: Jul. 4, 2024

(54) ACCESSORY AUTHENTICATION

(71) Applicant: Rivian IP Holdings, LLC, Plymouth, MI (US)

(72) Inventors: Austin Lee FREDERICKSON, Carlsbad, CA (US); Christian V. Elder, Irvine, CA (US); Joshua Bayer, Costa Mesa, CA (US); Kyle Lobo, Westchester, CA (US); Alex Cheng-Chi Yang, Redwood City, CA (US); Paula Michelle Lobaccaro, San Clemente, CA (US); Daniel Geoffrey Walker, Laguna Niguel, CA (US); Rachel Esther Gitajn, San Clemente, CA (US); Amil Jayesh Vira, East Brunswick, NJ (US); Zechariah John Rudnicki, Holt, MI (US)

(21) Appl. No.: 18/186,126

(22) Filed: Mar. 17, 2023

Related U.S. Application Data
(60) Provisional application No. 63/435,934, filed on Dec. 29, 2022.
(60) Provisional application No. 63/435,918, filed on Dec. 29, 2022.

(51) Int. Cl. G06F 21/44; G06F 21/81

(52) U.S. Cl. CPC G06F 21/44; G06F 21/81

(57) ABSTRACT

Particular embodiments may provide a computer-readable non-transitory storage media embodying software including instructions operable when executed to perform operations. The operations include detecting a signal indicating an accessory is coupled to an accessory port. In response to the signal, the operations further include determining whether the accessory is authorized to operate with the accessory port. In response to a determination that the accessory is authorized to operate with the accessory port, the operations further include transferring electrical power to the accessory.

### CROSS-REFERENCE TO RELATED APPLICATIONS

This application claims the benefit of priority under 35 U.S.C. § 119 to U.S. Provisional Application No. 63/435,918 filed Dec. 29, 2022, and U.S. Provisional Application No. 63/435,934 filed Dec. 29, 2022, the entire contents of which are hereby expressly incorporated by reference in their entireties.

### INTRODUCTION

Electrically powered vehicle accessories may attach to a vehicle to receive electrical power from the vehicle. While the accessories may have various designs, the attachment point on the vehicle may have a fixed design for accommodating the various designs of the accessories. This may compromise electrical safety if the accessories are not designed to adequately attach to and safely receive electrical power from the vehicle.

### BRIEF SUMMARY

Vehicles may be equipped with an accessory port that allows electrically powered vehicle accessories to attach to the vehicle and receive electrical power from the vehicle. However, some accessories may not be designed to safely receive electrical power from the vehicle. As such, it may be advantageous to differentiate accessories that are able to safely receive electrical power from accessories that are not. This may help improve safety by preventing unsafely designed accessories from attempting to receive electrical power from the accessory port. The present disclosure introduces a method for authenticating an accessory prior to transferring electrical power to the accessory. Authenticating the accessory may determine whether the accessory is able to safely receive electrical power from the vehicle's accessory port. The vehicle's accessory port may detect a signal indicating the accessory is coupled to the accessory port, and subsequently determine whether the accessory is authorized to operate with the accessory port to receive electrical power from the accessory port. If the determination is made that the accessory is authorized to operate with the accessory port, the accessory port may begin transferring electrical power to the accessory. On the other hand, if the determination is made that the accessory is not authorized to operate with the accessory port, the accessory port may withhold electrical power from the accessory.

In various embodiments, a computer-readable non-transitory storage media embodying software includes instructions operable when executed to perform operations. The operations include detecting a signal indicating an accessory is coupled to an accessory port. In response to the signal, the operations further include

In various embodiments, in response to a determination that the accessory is not authorized to operate with the accessory port, the operations further include withholding electrical power from the accessory.

In various embodiments, the operations further include transferring electrical power to the accessory at a first level prior to determining whether the accessory is authorized, and the electrical power transferred to the accessory in response to the determination that the accessory is authorized is at a second level greater than the first level.

In various embodiments, the operations further include establishing a wireless connection with the accessory, and the determination of whether the accessory is authorized to operate with the accessory port is based at least on the wireless connection with the accessory.

In various embodiments, the signal includes accessory data, the operations further include analyzing the accessory data, the determination of whether the accessory is authorized to operate with the accessory port is based at least on analyzing the accessory data, and analyzing the accessory data includes analyzing whether a set of attributes of the accessory meet a predetermined condition.

In various embodiments, the signal indicating the accessory is coupled to the accessory port is a first signal, and determining whether the accessory is authorized to operate with the accessory port includes detecting a second signal including accessory data.

In various embodiments, the first signal is detected using a first communication channel, and the second signal is detected using a second communication channel.

In various embodiments, a method includes receiving, by an accessory, electrical power at a first level. The method further includes activating the accessory based at least on the electrical power at the first level. The method further includes establishing a wireless connection between the accessory and the accessory port based at least on the electrical power at the first level. The method further includes transmitting, by the accessory, accessory data. The method further includes receiving, by the accessory, electrical power at a second level, wherein the second level is greater than the first level.

In various embodiments, the electrical power at the first level is less than a threshold level of electrical power needed to operate the accessory.

In various embodiments, prior to receiving electrical power at the first level, the method further includes transmitting, by the accessory, a signal indicating the accessory is coupled to the accessory port.

In various embodiments, the signal includes an interaction between the accessory port and the accessory, and the interaction includes one or more of a mechanical interaction, a magnetic interaction, a light-based interaction, a radio frequency interaction, and an electrical interaction.

In various embodiments, the signal is transmitted using a first communication channel, and transmitting the accessory data includes transmitting using a second communication channel.

In various embodiments, a system includes an accessory port to couple with an accessory. The system further includes a processor to detect a signal including an indication of an interaction between the accessory and the accessory port, wherein the processor includes instructions operable when executed to perform operations. The operations include determining whether the accessory is authorized to operate with the accessory port, and in response to a determination that the accessory is authorized to operate with the accessory port, permitting the accessory port to transfer electrical power to the accessory.

In various embodiments, the accessory port includes a mechanical button or switch, and the interaction includes triggering the mechanical button or switch when the accessory port is coupled with the accessory.

In various embodiments, the accessory port includes a first node of a communication circuit, the accessory includes a second node of the communication circuit, and the interaction includes exchanging information between the first node and the second node.

In various embodiments, the interaction includes measuring an electrical resistance of the accessory.

In various embodiments, the processor detects the signal via a wireless communication protocol.

In various embodiments, the accessory port includes a radio frequency sensor, and the interaction includes the radio frequency sensor detecting a radio frequency signal from the accessory.

In various embodiments, the accessory port includes a magnetic field sensor, and the interaction includes the magnetic field sensor detecting a magnetic field of the accessory.

In various embodiments, the accessory port includes an optical sensor, the accessory includes an optical emitter, and the interaction includes the optical sensor detecting a light from the optical emitter.

An authentication process provided herein may authenticate a vehicle accessory that couples to an accessory port of a vehicle prior to electrical power being transferred from the accessory port to the accessory. The authentication process may determine whether the accessory is able to safely receive electrical power from the vehicle's accessory port to help limit or prevent unsafely designed accessories from attempting to receive electrical power from the accessory port.

By authenticating vehicle accessories, the authentication process may save energy by withholding electrical power from accessories not designed to be able to safely receive the electrical power from the accessory port. This way, the authentication process may help reduce the amount of energy wasted or lost trying to supply electrical power to such vehicle accessories. The energy savings may in turn lead to a variety of benefits in reducing climate change, such as a reduction in greenhouse gas emissions and/or a reduced consumption of resources as power plants may not need to generate additional electrical power that may only end up being wasted or lost.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates a method with steps for an accessory port to authenticate an accessory.

FIG. 2 illustrates a method with details for the steps when an accessory port authenticates an accessory.

FIG. 3 illustrates a method with some steps that may be executed by an accessory and other steps that may be executed by an accessory port when authenticating the accessory.

FIG. 4 is a diagram illustrating exchanges between an accessory and an accessory port when authenticating the accessory.

FIG. 5 illustrates a system schematic of the components in an accessory port and an accessory that may communicate with one another when the accessory port authenticates the accessory.

FIG. 6 illustrates a perspective view of a truck bed with exemplary accessory ports.

FIG. 7 illustrates an example vehicle.

FIG. 8A is a schematic of an example computer system.

FIG. 8B illustrates example firmware for a vehicle ECU.

### DETAILED DESCRIPTION

The present disclosure introduces a method for authenticating an accessory prior to allowing the accessory to receive electrical power from an accessory port on a vehicle. The accessory port may first detect a signal that indicates the accessory has coupled to the accessory port. Before transferring electrical power, the accessory port may determine whether the accessory is authorized to operate with the accessory port as part of authenticating the accessory. This may include analyzing accessory data as well as first transferring a minimal amount of electrical power to the accessory before authenticating the accessory in order to receive the accessory data. In response to a determination that the accessory is authorized to operate with the accessory, the accessory port may transfer electrical power to the accessory to allow the accessory to become operational. On the other hand, in response to a determination that the accessory is not authorized to operate with the accessory, the accessory port may withhold electrical power from the accessory. This may help ensure that unsafely designed accessories do not attempt to receive electrical power from the accessory port.

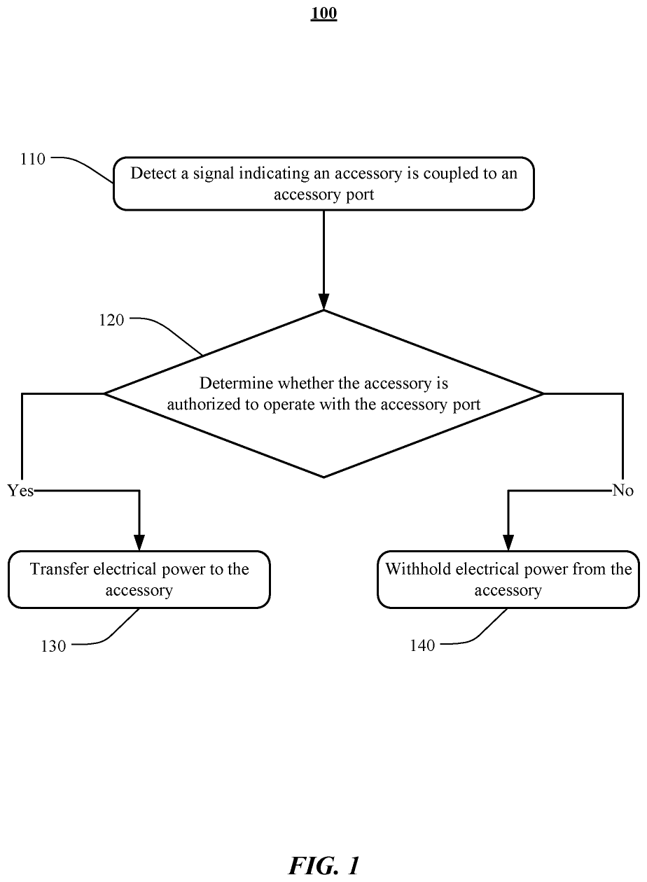

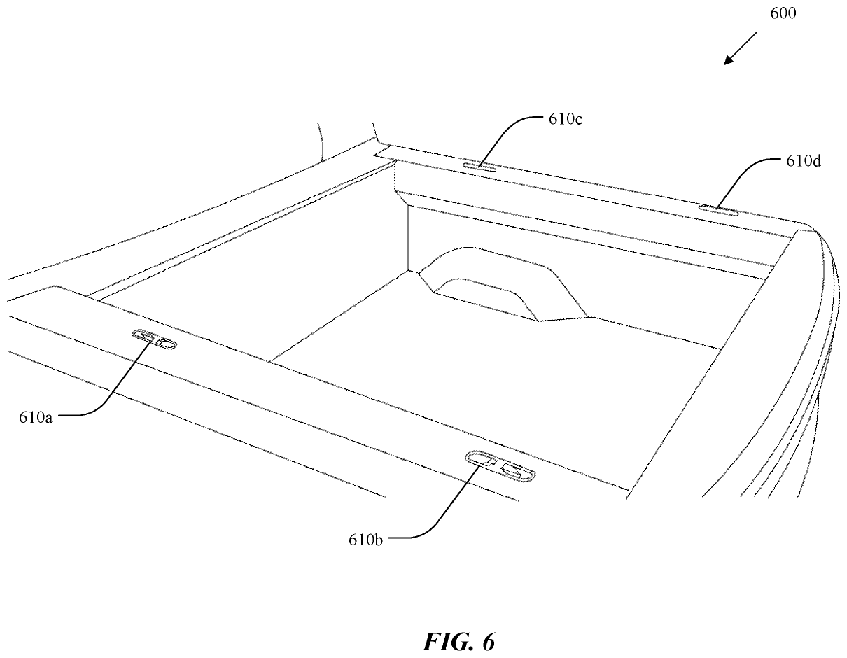

FIG. 1 illustrates a method 100 with steps for an accessory port to authenticate an accessory. As referenced herein, any method or step executed by the accessory port may also be executed by the vehicle that the accessory port may be a part of. An exemplary accessory port may be any one of the accessory ports 610a-610d of FIG. 6. Various steps of method 100 as described herein may be executed by a processor or similar computing unit, a sensor, and/or a power supply associated with the accessory port. In various embodiments, any component associated with the accessory port may be integrated directly into the accessory port, or integrated into the vehicle that the accessory may be part of while still remaining connected to the accessory port. As referenced herein, authenticating an accessory may also mean determining whether the accessory is authorized to operate with the accessory to receive electrical power from the accessory port. The method 100 may begin at step 110 where the accessory port may detect a signal from the accessory indicating the accessory is coupled to the accessory port. The detected signal may be many different types of signal and may depend on the specific authentication process relied upon by the accessory port. Consequently, the accessory port may also detect the signal in various ways, such as via various sensors. Potential authentication processes are described below with corresponding approaches for detecting the signal. The accessory coupled to the accessory port may be various electrically powered objects, such as an illuminated crossbar, electrically powered bikes (for charging), electrically powered camping gear (e.g., tents with built-in lights), canoes with an electric motor, or lights, among many others. In various embodiments, detecting the signal may mean the accessory has physically made contact with the accessory port, where the physical contact triggers the authentication process for the accessory. In various other embodiments, detecting the signal may mean the accessory has not yet physically made contact with the accessory port but has arrived in the proximity of the accessory port where the accessory port is able to detect the signal (e.g., via Bluetooth, NFC, etc.) from the accessory. This may mean the signal indicates that the accessory is seeking to couple with the accessory port to receive electrical power through the accessory port.

In response to detecting the signal, the method 100 may proceed to step 120 to determine whether the accessory is authorized to operate with the accessory port in order to authenticate the accessory. Determining whether the accessory is authorized may be based on many potential factors, such as whether the accessory is able to safely receive electrical power from the accessory port. The determination may include analyzing whether a set of attributes of the accessory meet a predetermined condition for operation with the accessory port. Various accessory attributes may be analyzed, such as the make or model of the accessory, data about any software that may be running on the accessory, limitations such as the maximum electrical resistance supported by the accessory, among many others. Possible predetermined conditions may include whether the accessory make or model is on a whitelist of accepted accessories, whether the accessory's software is a version known to be secure, whether the accessory's maximum electrical resistance is high enough to support the electrical current from the accessory port, among many others. The accessory port may obtain the accessory attributes through communicating with the accessory. More generally, the accessory may transmit accessory data, which may include the accessory attributes, to the accessory port which the accessory port subsequently analyzes to authenticate the accessory. To that end, the accessory and accessory port may include corresponding communication components that allow data to be exchanged between the accessory and accessory port, where many different implementations may be appropriate, which may also lead to different authentication processes.

One implementation may be electrical contacts on the accessory port and accessory that form a communication circuit when coming into contact with one another. The accessory may transmit accessory data to the accessory port via the electrical contacts and the communication circuit, which may be achieved in various ways. For example, the electrical contacts may form a controller area network (CAN) or a local interconnect network (LIN) bus that is capable of transmitting data between the electrical contacts on the accessory and accessory port. The electrical contacts may thus be nodes on a CAN or LIN bus that communicate with one another through a “handshake” mechanism. The electrical contacts on the accessory and accessory port may both transmit signals to each other and respond to each other's signals to exchange data and mutually identify each other. In various embodiments, the mutual identification itself may complete the authentication process for the accessory as any accessory capable of participating in the handshake mechanism may be authorized to operate with the accessory port. Alternatively, the handshake mechanism may include transmitting accessory data from the accessory to the accessory port where a processor associated with the accessory port may then analyze the accessory data to authenticate the accessory. In this implementation, the signal detected at step 110 may be the signal transmitted through the communication circuit as part of the handshake mechanism. The signal detected at step 110 indicating the accessory is coupled to the accessory port may authenticate the accessory, or another signal separate from that detected at step 110 may include accessory data that is used to authenticate the accessory.

Another implementation may be an electrical resistance sensor on the accessory port that measures the electrical resistance of the accessory. The electrical resistance sensor may be any appropriate sensor for measuring electrical resistance, such as an ohmmeter or a similar sensor. A processor associated with the accessory port may then retrieve the measured electrical resistance value to compare it against a stored threshold electrical resistance value for coupling with the accessory port. Whether the measured electrical resistance of the accessory meets the threshold value may indicate whether the accessory is authorized to operate with the accessory port. While accessories with at least the threshold electrical resistance may be authenticated, the specific electrical resistance of individual accessories may differ. Thus, the processor associated with the accessory port may be able to identify the particular accessory that is coupling to the accessory port based on the accessory's electrical resistance. In this implementation, the signal detected at step 110 may be a mechanical component, such as a button or switch, that may be manually or automatically triggered when the accessory makes contact with the accessory port. Triggering the mechanical component may then activate the electrical resistance sensor to measure and evaluate the accessory's electrical resistance.

A third implementation for the communication components may be a wireless transceiver of the accessory port that wirelessly communicates with a corresponding transceiver of the accessory using a communication protocol, such as Bluetooth or Wi-Fi. The wireless transceivers of the accessory port and accessory may first establish a wireless connection before the accessory's transceiver transmits accessory data to the accessory port's transceiver. The accessory's transceiver may automatically transmit accessory data upon the accessory coupling to the accessory port, or the accessory port's transceiver may first transmit a request for accessory data, with the accessory's transceiver providing accessory data as a response to that request. The accessory and accessory port may both include a processor, whether separate from or integrated with their corresponding wireless transceiver, for processing the signals from each other's transceivers. The accessory's processor may process the request for accessory data, while the processor associated with the accessory port may analyze the accessory data. The analysis of the accessory data may determine whether the accessory is authorized to operate with the accessory port, which may include analyzing whether accessory attributes in the accessory data meet a predetermined condition, as described above. In this implementation, the signal detected at step 110 may be the accessory data automatically transmitted from the accessory's wireless transceiver upon the accessory coupling to the accessory port.

A fourth implementation may be a radio frequency sensor on the accessory port, such as a near-field communication (NFC) reader, for detecting the radio frequency signals transmitted from a radio frequency emitter, such as an NFC tag, on the accessory. The radio frequency signals from the radio frequency emitter may include the accessory data that is subsequently analyzed by the processor associated with the accessory port to authenticate the accessory. The accessory's radio frequency emitter may be configured to continuously transmit the radio frequency signals regardless of whether the accessory is currently coupled to the accessory, as the signals may eventually be detected when the accessory couples to the accessory port. Alternatively, the accessory's radio frequency emitter may begin transmitting the radio frequency signals upon being activated, such as after the accessory couples to the accessory port. In this implementation with the radio frequency emitters and sensors, the signal detected at step 110 may be the radio frequency signal transmitted from the accessory, where the radio signal may also include the accessory data that is analyzed to authenticate the accessory.

A fifth implementation may be a mechanical component, such as a button or switch, that may be activated to indicate whether the accessory is authorized to operate with the accessory port. As opposed to a mechanical component that may be activated to trigger another process, such as activating the electrical resistance sensor as described above, the mechanical component may be structured such that it may only be activated by accessories that are able to safely receive electrical power from the accessory port and are thus authorized to operate with the accessory port. Such an accessory may automatically activate the mechanical component in the process of coupling with the accessory port, which may result in the accessory being authenticated. On the other hand, an accessory that is not able to safely receive electrical power from the accessory port may be unable to activate the mechanical component and thus is not authorized to operate with the accessory port. The mechanical component may also be manually activated, but may still be structured to only be activatable in the presence of an accessory that is able to safely receive electrical power from the accessory port. For example, the mechanical component may be a latch that, when activated, adjusts electrical contacts on the accessory port to touch the electrical contacts of the accessory. However, the latch may be locked or the two sets of electrical contacts may not be able to touch each other even with the latch activated in accessories that are not able to safely receive electrical power from the accessory port. In this implementation, the signal received at step 110 may be the mechanical component on the accessory port being activated, which may also authenticate the accessory at the same time.

A sixth implementation for the communication modules may be a magnetic field sensor, such as a hall effect sensor, on the accessory port that detects the magnetic field generated by a component, such as a magnet, of the accessory. Various aspects of the accessory's magnetic field, such as the strength and/or direction, may provide context that the hall effect sensor and/or the processor associated with the accessory port may use to determine whether the accessory is authorized to operate with the accessory port. For example, accessories with a magnetic field that is a certain strength and/or in a certain direction may be authorized to operate with the accessory port. The accessory port's magnetic field sensor may convert the accessory's magnetic field measurements into data that may subsequently be analyzed by the processor associated with the accessory port to authenticate the accessory. In this implementation, the signal detected at step 110 may be the accessory's magnetic field, which may also include the data for authenticating the accessory.

A seventh implementation for the communication modules may be an optical sensor on the accessory port that receives data from an optical emitter on the accessory that generates a light that includes accessory data. The optical sensor of the accessory port may convert the accessory data from the light to an electronic format such that the processor associated with the accessory port may analyze the accessory data to authenticate the accessory. In this implementation, the signal detected at step 110 may be the light generated from the accessory's optical emitter, which may also include the data that is analyzed to authenticate the accessory.

Although various implementations are described for how the accessory may transmit data to the accessory port for the accessory port to determine whether the accessory is authorized to operate with the accessory port, many others may also be appropriate. In various embodiments, a combination of the different implementations described above may be used to authenticate the accessory. For example, the accessory port may include a magnetic field sensor to first detect the presence of the accessory via the accessory's magnetic field generated by the accessory's magnet. The accessory port detecting the accessory's magnetic field may correspond to detecting the signal at step 110. The accessory port and accessory may each also include wireless transceivers to exchange accessory data once the signal (e.g., the accessory's magnetic field) indicating the accessory is coupled to the accessory port is detected. The accessory port's transceiver may transmit a request to the accessory's transceiver for accessory data upon the magnetic field sensor detecting the magnetic field. The accessory's transceiver may then respond with the accessory data for the processor associated with the accessory port to analyze and potentially authenticate the accessory.

In various embodiments, determining whether the accessory is authorized to operate with the accessory port may be based at least on analyzing accessory data. That is, analyzing the accessory data may be a necessary but insufficient step in authenticating the accessory. The analysis of the accessory data may identify the accessories that may not be able to safely receive electrical power from the accessory port, but there may be additional conditions that influence whether an accessory is fully authenticated, even for the accessories that may be able to safely receive electrical power from the accessory port. For example, authenticating the accessory may also depend on the level of electrical power available in the power supply associated with the accessory port, where the power supply may be a battery of the vehicle that the accessory port is a part of. The authentication process may prioritize maintaining enough electrical power in the power supply such that the vehicle may remain operable. As such, accessories that may be able to safely receive electrical power from the accessory port may still fail to be authenticated if the amount of electrical power remaining in the power supply at the time is below a threshold amount of electrical power that is needed to operate the vehicle.

The method 100 may subsequently proceed to step 130 in response to a determination that the accessory is authorized to operate with the accessory port, where the accessory port may transfer electrical power to the accessory, which may include a processor associated with the accessory port activating a power supply that transfers the electrical power to the accessory via the accessory port. As referenced herein, the accessory port transferring electrical power to the accessory may be understood as a power supply associated with the accessory port transferring electrical power to the accessory via the accessory port. At this stage, the accessory port, or the processor associated with the accessory port, may have determined that all necessary conditions for operating with the accessory port have been fulfilled, such as the accessory being able to safely receive electrical power from the accessory port and the power supply also having a sufficient amount of electrical power, and thus may safely transfer electrical power to the accessory.

Alternatively, the method 100 may proceed to step 140 in response to a determination that the accessory is not authorized to operate with the accessory port, where the accessory port may withhold electrical power from the accessory. This determination may have been made if any necessary condition for operating with the accessory port was not satisfied, such as the accessory not being able to safely receive electrical power from the accessory port or the power supply associated with the accessory port having an insufficient amount power to transfer to the accessory. The accessory may remain coupled to the accessory port, but may not receive any electrical power due to the failed authentication.

Particular embodiments may repeat one or more steps of the method of FIG. 1 where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates an example method for an accessory port to authenticate an accessory including the particular steps of the method of FIG. 1, this disclosure contemplates any suitable method for an accessory port to authenticate an accessory including any suitable steps, which may include all, some, or none of the steps of the method of FIG. 1, where appropriate. Furthermore, although this disclosure describes and illustrates particular components, devices, or systems carrying out particular steps of the method of FIG. 1, this disclosure contemplates any suitable combination of any suitable components, devices, or systems carrying out any suitable steps of the method of FIG. 1.

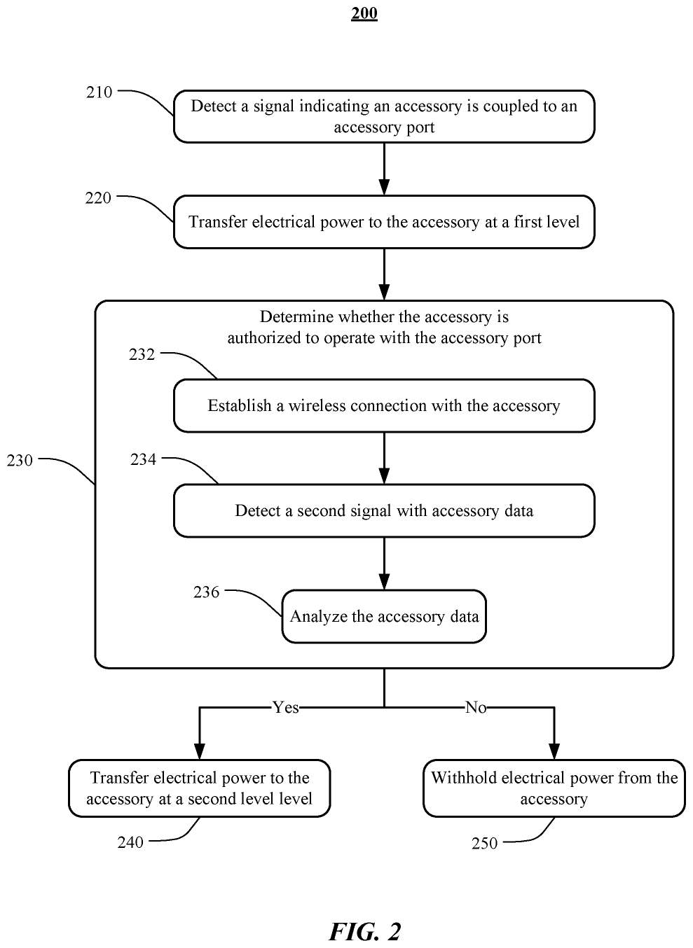

FIG. 2 illustrates method 200 with details for the steps when an accessory port authenticates an accessory. Similar to method 100, various steps of method 200 as described herein may be executed by a processor or similar computing unit, a sensor, and/or a power supply associated with the accessory port. The accessory port may also be any one of the accessory ports 610a-610d of FIG. 6. As described above with respect to method 100, various authentication processes may be implemented to authenticate the accessory. Method 200 may be directed to an authentication process that includes exchanging data between the accessory and accessory port using wireless transceivers, which may include various steps in addition to those described in method 100. This may be because the wireless transceiver of the accessory may require electrical power to be operational and participate in the authentication process. While the accessory port in some embodiments may be constantly activated to continuously transfer at least a small amount of electrical power to any accessory that couples to the accessory port, various embodiments of the accessory port may not transfer any electrical power by default and may transfer electrical power only after the accessory has been authenticated. This may be for any reason, such as to limit the amount of wasted electrical power or to restrict transferring electrical power to only accessories determined to be able to safely receive electrical power from the accessory port. Method 200 may advantageously allow a wireless transceiver of an accessory to receive electrical power and participate in the authentication process for the accessory before the accessory has been authenticated.

The method 200 may begin at step 210 where the accessory port may detect a signal from the accessory indicating the accessory is coupled to the accessory port. Because the accessory port may not transfer any electrical power by default, the accessory may not receive any electrical power upon coupling to the accessory port. As such, the signal transmitted by the accessory and detected by the accessory port at step 210 may be a signal that does not require electrical power to operate. For example, the signal detected at step 210 may include a magnetic field sensor, such as a hall effect sensor, of the accessory port detecting the magnetic field generated by a magnet on the accessory. Since the accessory's magnet may not require electrical power to operate, the accessory may be able to transmit the signal for the accessory port to detect despite not receiving any electrical power.

Once the accessory port detects the signal indicating the accessory is coupled, the method 200 may proceed to step 220 where the accessory port may transfer electrical power to the accessory at a first level. This may mean that a processor associated with the accessory port activates the power supply associated with the accessory port to begin transferring electrical power at the first level. The electrical power at the first level may be a minimal amount of electrical power that is enough to activate the wireless transceiver of the accessory to allow the transceiver to participate in the remainder of the authentication process. However, the electrical power at the first level may be insufficient to allow the accessory to become fully operational. For example, the accessory may be an illuminated crossbar that includes lights and a wireless transceiver. The electrical power at the first level may be sufficient to power the illuminated crossbar's wireless transceiver but insufficient to power the illuminated crossbar's lighting. It should be noted that the electrical power at the first level may be transferred to the accessory prior to determining whether the accessory is authorized to operate with the accessory port since the accessory's transceiver may need some amount of electrical power to be able to transmit the accessory data that is used to make the determination.

Method 200 may then proceed to step 230 to determine whether the accessory is authorized to operate with the accessory port. Because the wireless transceiver of the accessory may now be operational, the transceiver may transmit accessory data to the accessory port. To that end, the accessory port may first establish a wireless connection with the accessory at step 232. In particular, a wireless connection may be established between the wireless transceiver of the accessory and the wireless transceiver of the accessory port. The wireless transceivers may then exchange data using a communication protocol, such as Bluetooth or Wi-Fi. Since the wireless connection allows the accessory port to receive the accessory data which may be used to authenticate the accessory, the determination of whether the accessory is authorized to operate with the accessory port at step 230 may be based at least on the wireless connection established with the accessory at step 232.

The accessory port may then detect another signal with the accessory data at step 234. This signal with the accessory data may be transmitted from the accessory's wireless transceiver and detected by the accessory port's wireless transceiver. This may mean the accessory port detects two separate signals as part of method 200, where the signal indicating the accessory is coupled to the accessory port that was detected at step 210 may be the first signal and the signal detected at step 234 is the second signal with accessory data. The first and second signals may also be detected in different manners. As described above, the first signal may include a magnetic field sensor of the accessory port detecting the magnetic field generated by the accessory, whereas the second signal may include the accessory port's transceiver detecting the radio waves transmitted by the accessory's transceiver. The first and second signals being detected in different manners may also be considered as the signals being detected using different communication channels, where the first signal may be detected using a first communication channel (i.e., a magnetic field sensor detecting a magnetic field) and the second signal may be detected using a second communication channel (i.e., a transceiver detecting the radio waves transmitted by another transceiver).

At step 236, the accessory port may analyze the accessory data that was received as part of detecting the second signal at step 234. Specifically, a processor associated with the accessory port may extract the accessory data from the second signal to analyze the accessory data. This may include identifying a set of attributes that was included as part of the accessory data and analyzing whether the set of attributes meet a predetermined condition for operation with the accessory port. As described above with respect to step 120 of method 100, the set of attributes may include the make or model of the accessory, data about any software that may be running on the accessory, or component limitations such as the maximum electrical resistance supported by the accessory, among others. Although accessory attributes are described, the accessory data may include other information about the accessory which may also be analyzed by the processor associated with the accessory port. The determination of whether the accessory is authorized to operate with the accessory port may be based on the analysis of the accessory data.

The method 200 may then proceed to step 240 in response to a determination that the accessory is authorized to operate with the accessory port. Since the accessory is authorized to operate with the accessory port, the accessory port may transfer a sufficient amount of electrical power to the accessory to allow the accessory to become fully operational. The accessory port may already be transferring some electrical power to the accessory as a result of step 220, but that electrical power is at a first level that may be insufficient for the accessory to be fully operational. As such, the accessory port at step 240 may transfer electrical power at a second level to the accessory, where the electrical power at the second level is greater than the electrical power at the first level and may be sufficient for the accessory to become operational. This may include the processor associated with the accessory port interacting with the power supply to adjust the power supply to transfer electrical power at the second level to the accessory via the accessory port. Following on the example above, if the accessory is an illuminated crossbar that includes lights and a transceiver for participating in the authentication process, the electrical power at the first level may be sufficient for powering the illuminated crossbar's transceiver but insufficient to power the crossbar's lights, but the electrical power at the second level may be sufficient to power the crossbar's lights.

Alternatively, the method 200 may proceed to step 250 in response to a determination that the accessory is not authorized to operate with the accessory port. This may result in the accessory port withholding all electrical power from the accessory. As mentioned above, the accessory port may already be transferring electrical power at a first level to the accessory as a result of step 220. Now that the authentication process has completed and the accessory is determined to not be authorized to operate with the accessory port, withholding electrical power at step 250 may include terminating the electrical power being transferred to the accessory at the first level. The processor associated with the accessory port may deactivate the power supply to prevent any additional electrical power from being transferred to the accessory.

Method 200 may be described herein with respect to a wireless transceiver on the accessory that needs electrical power to participate in the authentication process, but method 200 may apply similarly in embodiments where the accessory includes other components that need electricity to participate in the authentication process. This may mean the wireless connection established at step 232 may be between components other than wireless transceivers, and the second signal detected at step 234 may be a signal other than one from a transceiver, such as a radio wave signal.

Particular embodiments may repeat one or more steps of the method of FIG. 2 where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates an example method with details for the steps when an accessory port authenticates an accessory including the particular steps of the method of FIG. 2, this disclosure contemplates any suitable method for an accessory port to authenticate an accessory including any suitable steps, which may include all, some, or none of the steps of the method of FIG. 2, where appropriate. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

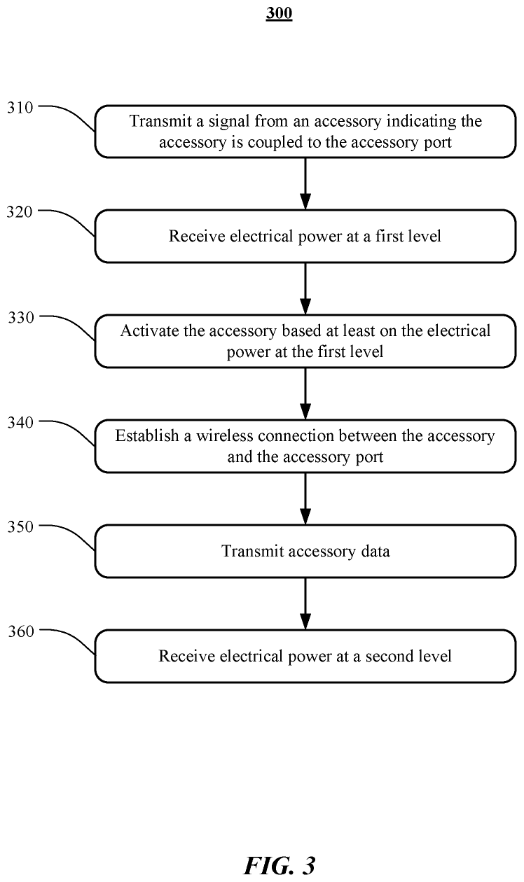

FIG. 3 illustrates a method 300 with steps that may be executed by an accessory when an accessory port authenticates the accessory, such as any one of the accessory ports 610a-610d of FIG. 6, when authenticating the accessory. Various steps of method 300 as described herein may be executed by a processor or similar computing unit and/or a sensor associated with the accessory. Similar to the accessory described with respect to method 200, the accessory of method 300 may include a wireless transceiver that requires electrical power to operate and participate in the authentication process, however, the method 300 may apply similarly in embodiments where the accessory includes other components that participate in the authentication process and operate using electrical power. The method 300 may begin at step 310 where the accessory may transmit a signal indicating the accessory is coupled to the accessory port. Transmitting this signal may include various types of interactions between the accessory and accessory port, which may depend on the authentication process that is implemented. Additionally, because the accessory port may not transfer any electrical power to the accessory by default, the interaction for transmitting the signal at step 310 may be one that does not require electrical power. For example, transmitting the signal may include a mechanical interaction where a component such as a button or switch is activated upon the accessory coupling to the accessory port, a magnetic interaction where a magnetic field sensor detects the magnetic field of the accessory, or a radio frequency interaction where a radio frequency sensor detects the radio frequency signal from a radio frequency emitter of the accessory, among many others.

Once the accessory port detects the signal from the accessory indicating the accessory has coupled to the accessory port, method 300 may proceed to step 320 where the accessory may receive electrical power at a first level from the accessory port. This may result from a processor associated with the accessory port activating a power supply associated with the accessory port to begin transferring electrical power at the first level to the accessory via the accessory port. As described above with respect to step 220 of method 200, the electrical power at the first level may be a minimal amount that allows the wireless transceiver of the accessory that participates in the authentication process to become operational, but may be an amount that is insufficient for the entire accessory to become operational. The electrical power at the first level may be less than a threshold level of electrical power needed to operate the accessory, but may be enough to operate the wireless transceiver. The method 300 may then proceed to step 330 where the accessory may activate, at least partially, based at least on the electrical power at the first level. That is, the accessory may activate the wireless transceiver using the electrical power at the first level to continue the authentication process, but may not activate the entirety of the accessory.

The method 300 may then proceed to step 340 where a wireless connection may be established between the accessory and the accessory port. In various embodiments, this may include establishing a wireless connection between the wireless transceiver of the accessory and a corresponding wireless transceiver of the accessory port. Because the wireless transceiver of the accessory may require electrical power to establish and maintain the wireless connection, the wireless connection may require electrical power from the accessory, and thus establishing the wireless connection may be based at least on the electrical power at the first level that the accessory received at step 320. The wireless connection may allow the accessory to transmit various accessory data to the accessory port that may be analyzed to determine whether the accessory is authorized to operate with the accessory port. Once the wireless connection is established, the wireless transceiver of the accessory may transmit accessory data to the accessory port using that wireless connection. At step 350, the accessory may transmit accessory data to the accessory port. This may include the wireless transceiver of the accessory transmitting the accessory data to the wireless transceiver of the accessory port using a communication protocol, such as Bluetooth or

Wi-Fi. Because the signal indicating the accessory is coupled to the accessory port that is transmitted at step 310 may not rely on electrical power while the accessory data transmitted at step 350 may rely on electrical power, the signal transmitted at step 310 and the accessory data transmitted at step 350 may be transmitted using different communication channels. The signal indicating the accessory is coupled to the accessory port may be transmitted using a first communication channel, such as a magnetic field sensor detecting a magnetic field, that does not rely on electrical power, while the accessory data may be transmitted using a second communication channel that does rely on electrical power, such as a wireless Bluetooth signal.

After the accessory port receives the accessory data that was transmitted from the accessory, the processor associated with the accessory port may analyze the accessory data to make a determination on whether the accessory is authorized to operate with the accessory port. As described above, this may include analyzing whether various attributes of the accessory, such as the make or model of the accessory, meets a predetermined condition for operating with the accessory port, such as the make or model being on a whitelist of accessories known to be able to safely receive electrical power from the accessory port. The determination on whether the accessory is authorized may also be based on additional factors besides the accessory data, such as whether the power supply associated with the accessory port has a threshold amount of electrical power. In response to determining that the accessory is authorized to operate with the accessory port, the processor associated with the accessory port may adjust the power supply associated with the accessory port to begin transferring electrical power at a second level to the accessory via the accessory port. The method 300 may then proceed to step 360 where the accessory may receive electrical power at the second level from the accessory port. As described above with respect to step 240 of method 200, since the accessory is authorized to operate with the accessory port, the accessory port may transfer a sufficient amount of electrical power to the accessory to allow the accessory to become fully operational. The electrical power at the second level may be greater than the electrical power at the first level that was transferred at step 320, where the second level may be sufficient for the accessory to become fully operational.

Particular embodiments may repeat one or more steps of the method of FIG. 3 where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method with steps that may be executed by an accessory when an accessory port authenticates the accessory including the particular steps of the method of FIG. 3, this disclosure contemplates any suitable method with steps that may be executed by an accessory when an accessory port authenticates the accessory including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

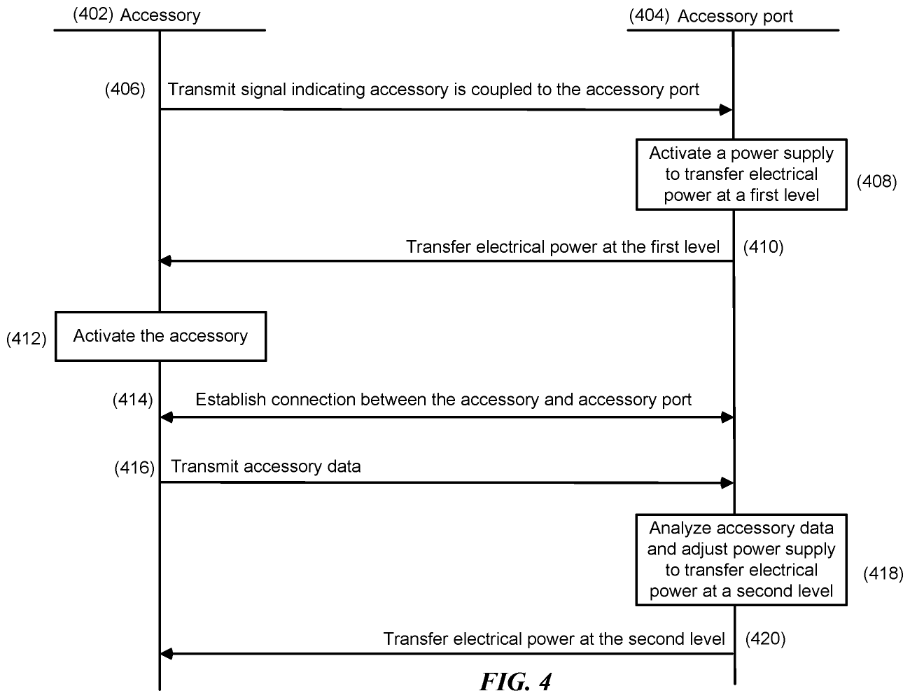

FIG. 4 is a diagram illustrating exchanges between an accessory 402 and an accessory port 404 when authenticating the accessory 402. The exchanges may correspond to various steps in methods 200 or 300 where the accessory 402 may include an electrically powered component that participates in the authentication process, such as a wireless transceiver. At exchange 406, the accessory 402 may transit a signal to the accessory port 404 indicating the accessory 402 is coupled to the accessory port 404. The signal may be various types of signals depending on the specific authentication process that is implemented, such as a magnetic field sensor of the accessory port 404 detecting the magnetic field of the accessory 402. At 408, upon receiving the signal indicating the accessory 402 is coupled to the accessory port 404, a processor associated with the accessory port 404 may activate a power supply associated with the accessory port 404 to transfer electrical power at a first level. At exchange 410, the power supply may transfer the electrical power at the first level to the accessory 402 via the accessory port 404. At 412, the accessory 402 may activate using the electrical power at the first level. This may include activating the accessory component that will participate in the authentication process, such as the wireless transceiver, but may not include activating the entire accessory. At exchange 414, the accessory 402 and accessory port 404 may establish a connection between each other. This may include establishing a wireless connection between the wireless transceiver of the accessory 402 and the corresponding wireless transceiver of the accessory port 404. At exchange 416, the accessory 402 may transmit accessory data to the accessory port 404 using the connection established in the previous exchange. With the accessory data, at 418, the processor associated with the accessory port 404 may analyze the accessory data, and in response to determining that the accessory 402 is authorized to operate with the accessory port 404, adjust the power supply to transfer electrical power at a second level. The electrical power at the second level may be greater than the electrical power at the first level and may be sufficient to allow the accessory 402 to become fully operational. Then at exchange 420, the power supply associated with the accessory port 404 may transfer the electrical power at the second level to the accessory 402 via the accessory port 404, allowing the accessory 402 to become fully operational.

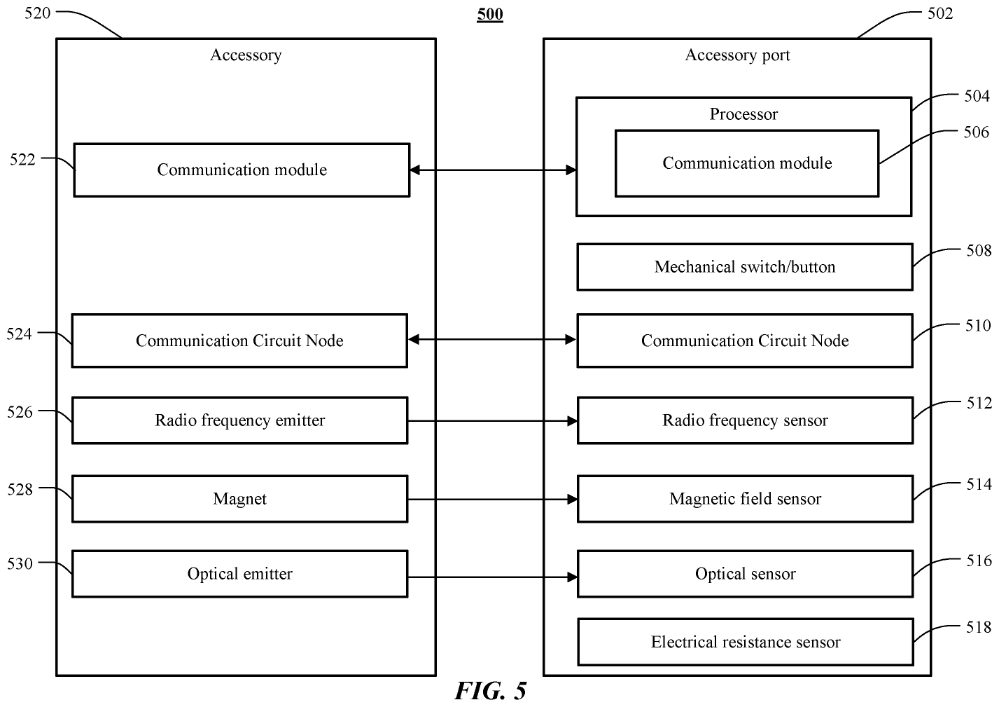

FIG. 5 illustrates a system schematic 500 of the components in an accessory port 502 and an accessory 520 that may communicate with one another when the accessory port 502 authenticates the accessory 520, such as through executing methods 200 or 300. The accessory port 502 may include a processor 504 for detecting a signal that indicates the accessory 520 is coupled to the accessory port 502 where the signal may include an indication of an interaction between the accessory 520 and the accessory port 502. The interaction may be various different types of interactions depending on the process used to authenticate the accessory 520, and as a result, may involve different components of the accessory 520 and accessory port 502 that perform the interaction. The processor 504 may receive accessory data through that interaction and subsequently analyze that data to determine whether the accessory 520 is authorized to operate with the accessory port 502. In response to a determination that the accessory 520 is authorized to operate with the accessory port 502, the processor 504 may permit the accessory port 502 to transfer electrical power to the accessory 520. The processor 504 may activate a power supply associated with the accessory port 502 to being transferring electrical power to the accessory 520 via the accessory port 502. In various embodiments where electrical power may be transferred to the accessory 520 at a first level prior to being authenticated to allow a component of the accessory 520 to participate in the authentication process, as described above with respect to methods 200 or 300, the processor 504 may adjust the power supply to begin transferring electrical power at a second level greater than the first level in response to determining the accessory 520 is authorized to operate with the accessory port 502. On the other hand, in response to a determination that the accessory 520 is not authorized to operate with the accessory port 502, the processor 504 may prevent the accessory port 502 from transferring electrical power to the accessory 520. The processor 504 may keep the power supply associated with the accessory port 502 deactivated if no electrical power is already being transferred when the determination is made, or in embodiments where the power supply may have begun transferring electrical power at a first level to the accessory 520, the processor 504 may deactivate the power supply associated with the accessory port 502 to terminate the transfer of electrical power at the first level.

As described above, there may be various different types of interactions between the accessory port 502 and accessory 520. This may also mean the accessory port 502 and accessory 520 include different components that perform that interaction. For example, the interaction may be a wireless interaction that includes the processor 504 detecting the signal from the accessory 520 via a wireless communication protocol. The processor 504 may include a communication module 506 that allows the processor 504 to detect the signal transmitted by a corresponding communication module 522 of the accessory 520. The communication modules 506 and 522 may be any components capable of wirelessing transmitting and detecting signals via a wireless communication protocol, such as wireless transceivers as described above with respect to method 200. The wireless transceivers may exchange data through signals using any wireless communication protocol, such as Bluetooth or Wi-Fi. The data may include accessory data that the processor 504 may analyze to determine whether the accessory 520 is authorized to operate with the accessory port 502. The communication module 506 is illustrated as being integrated into the processor 504 which may allow the processor 504 to wirelessly communicate with the communication module 522 of the accessory 520. In various other embodiments, the communication module 506 may be an individual component separate from but still connected to the processor 504, where the communication module 506 may detect the signals from the communication module 522 of the accessory 520 before the processor 504 extracts data from that signal to analyze.

The interaction between the accessory port 502 and accessory 520 may also be a mechanical interaction that includes a mechanical button or switch 508 on the accessory port 502 that is triggered when the accessory port 502 is coupled with the accessory 520. The button or switch 508 may be triggered automatically when the accessory 520 couples to the accessory port 502, or it may be triggered manually after coupling. The button or switch 508 being triggered may indicate that the accessory 520 is authorized to operate with the accessory port 502. As a result, the button or switch 508 being triggered may directly cause the power supply associated with the accessory port 502 to begin transferring electrical power to the accessory 520, or it may cause the processor 504 to activate the power supply and begin transferring electrical power to the accessory 520.

The interaction between the accessory port 502 and accessory 520 may also be an electrical interaction that includes a communication circuit node 510 on the accessory port 502 that interacts with a corresponding communication circuit node 524 on the accessory 520. The communication circuit node 510 of the accessory port 502 may be the first node of a communication circuit, and the communication circuit node 524 of the accessory may be the second node of the communication circuit. The interaction between the accessory port 502 and accessory 520 may include exchanging data between the first node and the second node via electrical signals through the communication circuit. For example, the accessory port 502 and accessory 520 may each include electrical contacts that form a CAN or LIN bus when they come into contact with one another. The CAN or LIN bus may be the communication circuit that is capable of exchanging data between the accessory port 502 and accessory 520 via a “handshake” mechanism, where the electrical contacts on the accessory port 502 and accessory 520 may be the communication circuit nodes 510 and 524. The data may include accessory data that may be analyzed to determine whether the accessory 520 is authorized to operate with the accessory port 502.

The interaction between the accessory port 502 and the accessory 520 may also be a radio frequency interaction that includes a radio frequency sensor 512 on the accessory port 502 that detects a radio frequency signal transmitted from a radio frequency emitter 526 on the accessory 520. The radio frequency signal may include accessory data that may be analyzed to determine whether the accessory 520 is authorized to operate with the accessory port 502. The radio frequency sensor 512 and radio frequency emitter 526 may also be various implementations. For example, the radio frequency sensor 512 may be an NFC reader that detects the radio frequency signal from an NFC tag that is the radio frequency emitter 526.

The interaction between the accessory port 502 and the accessory 520 may also be a magnetic interaction that includes a magnetic field sensor 514 on the accessory port 502 that detects the magnetic field of the accessory 520 which may be generated by a magnet 528. The magnetic field sensor 514 may measure various aspects of the magnetic field, such as the strength and/or direction. The magnetic field sensor 514 may then convert those measurements to data that may be analyzed, such as by the processor 504, to determine whether the accessory 520 is authorized to operate with the accessory port 502. The magnetic field sensor 514 may also be implemented in various ways, such as with a hall effect sensor as described above with respect to FIG. 1.

The interaction between the accessory port 502 and the accessory 520 may also be a light-based interaction that includes an optical sensor 516 of the accessory port 502 that detects a light generated by an optical emitter 530 of the accessory 520. The light generated by the optical emitter 530 may include accessory data that may be analyzed to determine whether the accessory 520 is authorized to operate with the accessory port 502. The optical sensor 516 may detect the light and convert the light to data that may then be analyzed, such as by the processor 504.

The interaction between the accessory port 502 and the accessory 520 may also be a different electrical interaction that includes an electrical resistance sensor 518 of the accessory port 502 that measures an electrical resistance of the accessory 520. The electrical resistance sensor 518 may transfer a small amount of electrical power from the accessory port 502 to the accessory 520 to measure the electrical resistance of the accessory 520. The measured electrical resistance may then determine whether the accessory 520 is authorized to operate with the accessory port 502. To further determine whether the accessory 520 is able to safely receive electrical power from the accessory port 502 as part of determining whether the accessory 520 is authorized, the electrical resistance sensor 518 may also measure the electrical impedance and/or electrical capacitance of the accessory 520, with the measurements also being factors in determining whether the accessory 520 is authorized.

The schematic 500 is illustrated with a plurality of different components, but various embodiments may include many other components depending on the process used to authenticate the accessory 520. Of the components illustrated and described herein, the accessory port 502 and accessory 520 may include just one of the components instead of all the components, as one may be sufficient to adequately authenticate the accessory 520 and determine whether the accessory 520 is authorized to operate with the accessory port 502. For example, various embodiments may include just the communication circuit nodes 510 and 524, but not the other components. On the other hand, various other embodiments of the accessory port 502 and accessory 520 may also include any combination of the components, such as the processor 504 along with the communication modules 506 and 522, as well as the magnetic field sensor 514 and the magnet 528. The components in schematic 500 may also be illustrated as being integrated into the accessory port 502 and accessory 520, but in various embodiments, the components may be separate from the accessory port 502 or accessory 520 but remain associated with them to complete the authentication process. For example, the processor 504 of the accessory port 502 may not be integrated into the accessory port 502, but is integrated into another component of a vehicle, such as a vehicle control unit. Even so, the processor 504 may still be able to analyze the accessory data transmitted from the accessory 520 to determine whether the accessory 520 is authorized to operate with the accessory port 502.

FIG. 6 illustrates a perspective view of a truck bed 600 with exemplary accessory ports 610a-610d. The accessory ports 610a-610d may couple to accessories and subsequently transfer electrical power to the accessories once the accessories are authenticated. The accessory ports 610a-610d may each include a connector component for physically securing an accessory to the accessory port and an electrical component that allows an electrical current to flow from the accessory port to the accessory when electrical power is being transferred to the accessory. The accessory ports 610a-610d may be illustrated as being on the truck bed 600, but the accessory ports 610a-610d may be located on any exterior surface of a vehicle, such as the roof, doors, the hood, etc., or anywhere on the interior of the vehicle.

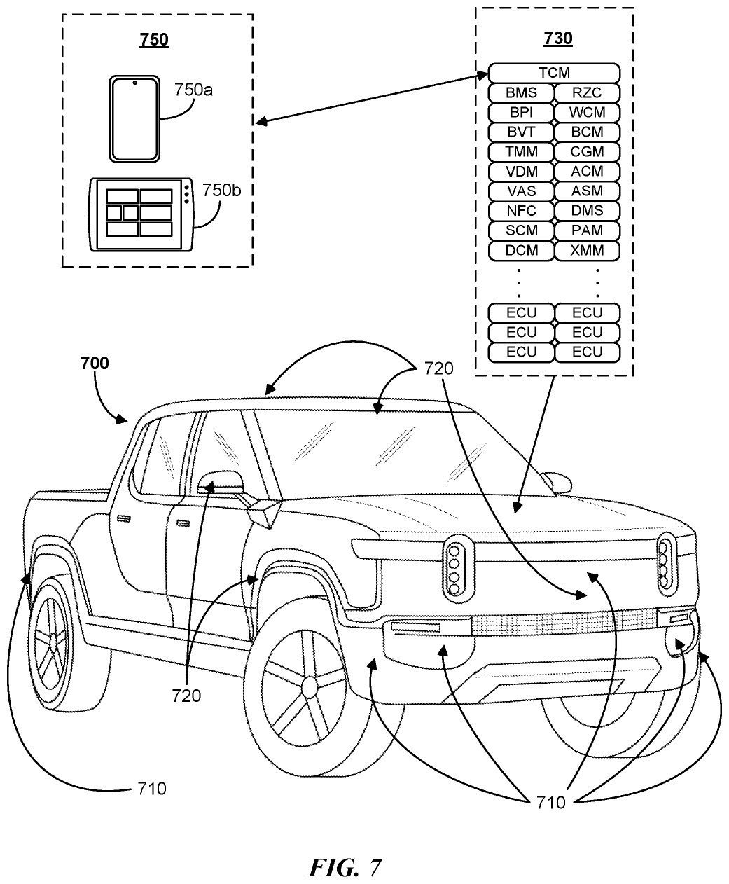

FIG. 7 illustrates an example vehicle 700. Vehicle 700 may include multiple sensors 710, multiple cameras 720, and a control system 730. In some embodiments, vehicle 700 may be able to pair with a computing device 750 (e.g., smartphone 750a, tablet computing device 750b, or a smart vehicle accessory). As an example and not by way of limitation, a sensor 710 may be an accelerometer, a gyroscope, a magnetometer, a global positioning satellite (GPS) signal sensor, a vibration sensor (e.g., piezoelectric accelerometer), a light detection and ranging (LiDAR) sensor, a radio detection and ranging (RADAR) sensor, an ultrasonic sensor, a temperature sensor, a pressure sensor, a humidity sensor, a chemical sensor, an electromagnetic proximity sensor, an electric current sensor, another suitable sensor, or a combination thereof. As an example and not by way of limitation, a camera 720 may be a still image camera, a video camera, a 3D scanning system (e.g., based on modulated light, laser triangulation, laser pulse, structured light, light detection and ranging (LiDAR)), an infrared camera, another suitable camera, or a combination thereof. Vehicle 700 may include various controllable components (e.g., doors, seats, windows, lights, HVAC, entertainment system, security system), instrument and information displays and/or interactive interfaces, functionality to pair a computing device 750 with the vehicle (which may enable control of certain vehicle functions using the computing device 750), and functionality to pair accessories with the vehicle, which may then be controllable through an interactive interface in the vehicle or through a paired computing device 750.

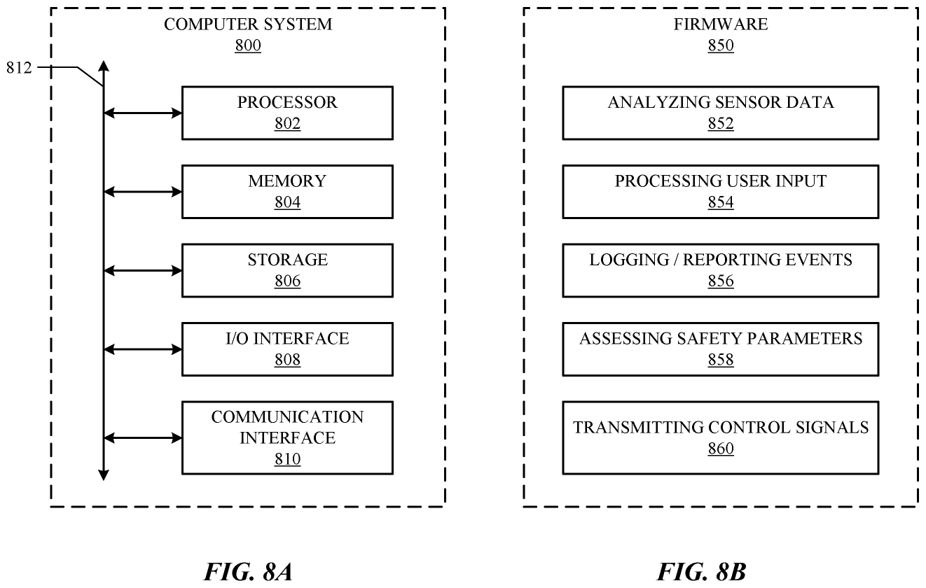

Control system 730 may enables control of various systems on-board the vehicle. As shown in FIG. 7, control system 730 may comprise one or more electronic control units (ECUs), each of which are dedicated to a specific set of functions. Each ECU may be a computer system (as described further in FIG. 8), and each ECU may include functionality provide by one or more of the example ECUs described below.

Features of embodiments as described herein may be controlled by one or more ECUs that provide functionality related to the battery pack of the vehicle. A Battery Management System (BMS) ECU may control and monitor a number of different aspects related to the electric vehicle battery system. Functions that may be controlled by the BMS may include, by way of example and not limitation, controlling the battery pack contactors and pre-charge relay, monitoring the high voltage connector, measuring the pack puncture sensor resistance and pack water sensor resistance, controlling the battery pack fans, measuring busbar temperature, communicating with the BPI and BVT ECUs, and calculate state-of-charge (SoC) and battery state-of-health (SoH). A Battery Power Isolation (BPI) ECU may provide high-voltage sensing, measure the battery pack current, and facilitate determination of pack isolation. A Balancing Voltage Temperature (BVT) ECU may monitor battery module cell voltages, monitor temperature, and execute cell balancing.

Features of embodiments as described herein may be controlled by one or more ECUs that provide functionality to control access to the vehicle. A Vehicle Access System (VAS) ECU may provide passive/active wireless sensors (e.g., Bluetooth) authorizing accessing (i.e., locking or unlocking) the vehicle. A Near-Field Communication (NFC) ECU may support an NFC reader embedded in the vehicle (e.g., in the driver-side exterior door handle or in the armrest of the interior, driver-side door panel) for user authentication.

Features of embodiments as described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device 750, in-vehicle navigation, vehicle-to-vehicle communication, communication between the vehicle and landscape features (e.g., automated toll road sensors, automated toll gates, power dispensers at charging stations), or automated calling functionality.

Vehicle 700 may include one or more additional ECUs, such as, by way of example and not limitation: a Central Gateway Module (CGM) ECU, a Vehicle Dynamics Module (VDM) ECU, an Experience Management Module (XMM) ECU, a Body Control Module (BCM) ECU, a Scat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 700 is an electric vehicle, one or more ECUs may provide functionality related to the battery pack of the vehicle, such as a Thermal Management Module (TMM) ECU.

FIG. 8A illustrates an example computer system 800. Computer system 800 may include a processor 802, memory 804, storage 806, an input/output (I/O) interface 808, a communication interface 810, and a bus 812. Although this disclosure describes one example computer system including specified components in a particular arrangement, this disclosure contemplates any suitable computer system with any suitable number of any suitable components in any suitable arrangement. As an example and not by way of limitation, computer system 800 may be an electronic control unit (ECU), an embedded computer system, a system-on-chip, a single-board computer system, a desktop computer system, a laptop or notebook computer system, a mainframe, a mesh of computer systems, a mobile telephone, a personal digital assistant, a server computing system, a tablet computer system, or a combination of two or more of these. Where appropriate, computer system 800 may include one or more computer systems 800; be unitary or distributed, span multiple locations, machines, or data centers; or reside in a cloud, which may include one or more cloud components in one or more networks. Where appropriate, computer system(s) 800 may perform, at different times or at different locations, in real time or in batch mode, one or more steps of one or more methods described or illustrated herein.

Processor 802 may include hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. Processor 802 may include one or more internal caches for data, instructions, or addresses.

In particular embodiments, memory 804 includes main memory for storing instructions for processor 802 to execute or data for processor 802 to operate on. In particular embodiments, one or more memory management units (MMUs) reside between processor 802 and memory 804 and facilitate accesses to memory 804 requested by processor 802. In particular embodiments, memory 804 includes random access memory (RAM). This disclosure contemplates any suitable RAM.

In particular embodiments, storage 806 includes mass storage for data or instructions. As an example and not by way of limitation, storage 806 may include a removable disk drive, flash memory, an optical disc, a magneto-optical disc, magnetic tape, or a Universal Serial Bus (USB) drive or two or more of these. Storage 806 may include removable or fixed media and may be internal or external to computer system 800. Storage 806 may include any suitable form of non-volatile, solid-state memory or read-only memory (ROM).

In particular embodiments, I/O interface 808 includes hardware, software, or both, providing one or more interfaces for communication between computer system 800 and one or more input and/or output (I/O) devices. Computer system 800 may be communicably connected to one or more of these I/O devices, which may be incorporated into, plugged into, paired with, or otherwise communicably connected to vehicle 700 (e.g., through the TCM ECU). An input device may include any suitable device for converting volitional user input into digital signals that can be processed by computer system 800, such as, by way of example and not limitation, a steering wheel, a touch screen, a microphone, a joystick, a scroll wheel, a button, a toggle, a switch, a dial, or a pedal. An input device may include one or more sensors for capturing different types of information, such as, by way of example and not limitation, sensors 710 described above. An output device may include devices designed to receive digital signals from computer system 800 and convert them to an output format, such as, by way of example and not limitation, speakers, headphones, a display screen, a heads-up display, a lamp, a smart vehicle accessory, another suitable output device, or a combination thereof. This disclosure contemplates any suitable I/O devices and any suitable I/O interfaces 808 for them. I/O interface 808 may include one or more I/O interfaces 808, where appropriate.

In particular embodiments, communication interface 810 includes hardware, software, or both providing one or more interfaces for data communication between computer system 800 and one or more other computer systems 800 or one or more networks. Communication interface 810 may include one or more interfaces to a controller area network (CAN) or to a local interconnect network (LIN). Communication interface 810 may include one or more of a serial peripheral interface (SPI) or an isolated serial peripheral interface (isoSPI). In some embodiments, communication interface 810 may include a network interface controller (NIC) or network adapter for communicating with an Ethernet or other wire-based network or a wireless NIC (WNIC) or wireless adapter for communicating with a wireless network, such as a WI-FI network or a cellular network.

In particular embodiments, bus 812 includes hardware, software, or both coupling components of computer system 800 to each other. Bus 812 may include any suitable bus, as well as one or more buses 812, where appropriate. Although this disclosure describes a particular bus, any suitable bus or interconnect is contemplated.

Herein, a computer-readable non-transitory storage medium or media may include one or more semiconductor-based or other integrated circuits (ICs) (such, as for example, field-programmable gate arrays or application-specific ICs), hard disk drives, hybrid hard drives, optical discs, optical disc drives, magneto-optical discs, magneto-optical drives, solid-state drives, RAM drives, any other suitable computer-readable non-transitory storage media, or any suitable combination. A computer-readable non-transitory storage medium may be volatile, non-volatile, or a combination of volatile and non-volatile, where appropriate.

FIG. 8B illustrates example firmware 850 for a vehicle ECU 800 as described with respect to control system 730. Firmware 850 may include functions 852 for analyzing sensor data based on signals received from sensors 710 or cameras 720 received through communication interface 810. Firmware 850 may include functions 854 for processing user input (e.g., directly provided by a driver of or passenger in vehicle 700, or provided through a computing device 750) received through I/O interface 808. Firmware 850 may include functions 856 for logging detected events (which may be stored in storage 806 or uploaded to the cloud), as well as functions for reporting detected events (e.g., to a driver or passenger of the vehicle through an instrument display or interactive interface of the vehicle, or to a vehicle manufacturer, service provider, or third party through communication interface 810). Firmware 850 may include functions 858 for assessing safety parameters (e.g., monitoring the temperature of a vehicle battery or the distance between vehicle 700 and nearby vehicles). Firmware 850 may include functions 860 for transmitting control signals to components of vehicle 700, including other vehicle ECUs 800.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A computer-readable non-transitory storage media embodying software comprising instructions operable when executed to perform operations, the operations comprising:
detecting a signal indicating an accessory is coupled to an accessory port;
in response to the signal, determining whether the accessory is authorized to operate with the accessory port; and
in response to a determination that the accessory is authorized to operate with the accessory port, transferring electrical power to the accessory.

2. The non-transitory storage media of claim 1, the operations further comprising:
in response to a determination that the accessory is not authorized to operate with the accessory port, withholding electrical power from the accessory.

3. The non-transitory storage media of claim 1, the operations further comprising transferring electrical power to the accessory at a first level prior to determining whether the accessory is authorized, wherein the electrical power transferred to the accessory in response to the determination that the accessory is authorized is at a second level greater than the first level.

4. The non-transitory storage media of claim 1, the operations further comprising establishing a wireless connection with the accessory, wherein the determination of whether the accessory is authorized to operate with the accessory port is based at least on the wireless connection with the accessory.

5. The non-transitory storage media of claim 1, wherein the signal comprises accessory data, the operations further comprising analyzing the accessory data, wherein the determination of whether the accessory is authorized to operate with the accessory port is based at least on analyzing the accessory data, and wherein analyzing the accessory data comprises analyzing whether a set of attributes of the accessory meet a predetermined condition.

6. The non-transitory storage media of claim 1, wherein the signal indicating the accessory is coupled to the accessory port is a first signal, and wherein determining whether the accessory is authorized to operate with the accessory port comprises detecting a second signal comprising accessory data.

7. The non-transitory storage media of claim 6, wherein the first signal is detected using a first communication channel, and wherein the second signal is detected using a second communication channel.

8. A method comprising:
receiving, by an accessory, electrical power at a first level;
activating the accessory based at least on the electrical power at the first level;
establishing a wireless connection between the accessory and the accessory port based at least on the electrical power at the first level;
transmitting, by the accessory, accessory data; and
receiving, by the accessory, electrical power at a second level, wherein the second level is greater than the first level.

9. The method of claim 8, wherein the electrical power at the first level is less than a threshold level of electrical power needed to operate the accessory.

10. The method of claim 8, further comprising:
prior to receiving electrical power at the first level, transmitting, by the accessory, a signal indicating the accessory is coupled to the accessory port.

11. The method of claim 10, wherein the signal comprises an interaction between the accessory port and the accessory, wherein the interaction comprises one or more of a mechanical interaction, a magnetic interaction, a light-based interaction, a radio frequency interaction, and an electrical interaction.

12. The method of claim 10, wherein the signal is transmitted using a first communication channel, and wherein transmitting the accessory data comprises transmitting using a second communication channel.

13. A system, comprising:
an accessory port to couple with an accessory; and
a processor to detect a signal comprising an indication of an interaction between the accessory and the accessory port, wherein the processor comprises instructions operable when executed to perform operations, the operations comprising:
determining whether the accessory is authorized to operate with the accessory port, and
in response to a determination that the accessory is authorized to operate with the accessory port, permitting the accessory port to transfer electrical power to the accessory.

14. The system of claim 13, wherein the accessory port comprises a mechanical button or switch, and wherein the interaction comprises triggering the mechanical button or switch when the accessory port is coupled with the accessory.

15. The system of claim 13, wherein the accessory port comprises a first node of a communication circuit, wherein the accessory comprises a second node of the communication circuit, and wherein the interaction comprises exchanging information between the first node and the second node.

16. The system of claim 13, wherein the interaction comprises measuring an electrical resistance of the accessory.

17. The system of claim 13, wherein the processor detects the signal via a wireless communication protocol.

18. The system of claim 13, wherein the accessory port comprises a radio frequency sensor, and wherein the interaction comprises the radio frequency sensor detecting a radio frequency signal from the accessory.

19. The system of claim 13, wherein the accessory port comprises a magnetic field sensor, and wherein the interaction comprises the magnetic field sensor detecting a magnetic field of the accessory.

20. The system of claim 13, wherein the accessory port comprises an optical sensor, wherein the accessory comprises an optical emitter, and wherein the interaction comprises the optical sensor detecting a light from the optical emitter.
